(19) United States
(12) Patent Application Publication
(10) Pub. No.: US 2011/0160927 A1
(43) Pub. Date: Jun. 30, 2011

(54) Method for Prediction for Nonlinear Seasonal Time Series

(76) Inventors: Kevin W. Wilson, Cambridge, MA (US); Xiaoqian Jiang, Cambridge, MA (US)

(21) Appl. No.: 12/650,452

(22) Filed: Dec. 30, 2009

(51) Int. Cl. G06N 5/02; G06F 1/26

(52) U.S. Cl. 700/291; 706/58

(57) ABSTRACT

A method predicts nonlinear seasonal time series data. More particularly, the method predicts short term power demand. The method uses an exponential smoothing technique and dynamic modeling of seasonal time series data with kernels. The kernels are used to predict future values of the time series from past values using nonlinear functions such as a least-squares radial basis function or support vector regression using a Gaussian kernel.

### FIELD OF THE INVENTION

This invention relates generally to predicting future values of a time series from past values of time series that have seasonal patterns and nonlinear relationships between past values and future values, and more particularly to predicting short term power demand based on seasonal variations.

### BACKGROUND OF THE INVENTION

A time series is a sequence of values, for example the sequence of average daily temperatures, or the sequence of maximum daily electrical loads for a geographic region. A seasonal pattern is some characteristic approximately repeating pattern that has a known period. For example, the daily temperature time series has a repeating pattern with a period of one year, with warmer temperatures in the summer and colder temperatures in the winter. The daily electrical load time series has a seasonal pattern with a period of one week that is due to the weekly pattern of human activity. The daily electrical load time series also has a seasonal pattern with a period of one year that occurs primarily because power demand changes with the weather conditions. It is also possible for one time series to have multiple seasonal patterns with different periods. For example, the task of time series prediction is to predict the daily average temperature tomorrow, or a week in the future, based on past values of the time series.

A conventional method for predicting seasonal time series Xₜ uses Holt-Winters smoothing:

Lₜ=α(Xₜ/Iₜ₋ₚ)+(1−α)(Lₜ₋₁+Tₜ₋₁) (1)

Tₜ=γ(Lₜ−Lₜ₋₁)+(1−γ)Tₜ₋₁ (2)

Iₜ=δ(Xₜ/Lₜ)+(1−δ)Iₜ₋ₚ (3)

where Lₜ, Tₜ, and Iₜ denote the local mean level, trend, and seasonal index at time t, respectively. Parameters α, γ, δ denote smoothing parameters for updating the mean level, trend, and seasonal index, respectively, and p denotes the duration of the seasonal pattern.

The prediction \hat{X} made at time t of the value k in the future is

\hat{X}ₜ(k)=(Lₜ+kTₜ)Iₜ₋ₚ₊ₖ (4)

By updating Lₜ, Tₜ, and Iₜ at each time step t, and by using the prediction Equation (4), future values of the time series can be predicted.

By using a level and a trend term, Holt-Winters smoothing assumes a simple linear model of the non-seasonal component of the time series. This linear assumption is appropriate for some, but not all time series.

### SUMMARY OF THE INVENTION

The embodiments of the invention provide a method for prediction for nonlinear seasonal time series data. More particularly, the method predicts short term power demand. The method is an improvement on the conventional exponential smoothing technique of Holt-Winters by modeling dynamic seasonal time series data with kernels. The kernels are used to predict future values of the time series using support vector regression.

### BRIEF DESCRIPTION OF THE DRAWINGS

FIG. 1 is a flow diagram of a method for predicting time series according to embodiments of the invention.

### DETAILED DESCRIPTION OF THE PREFERRED EMBODIMENTS

The embodiments of our invention provide a method for predicting future values of a time series from past values of time series that have seasonal patterns and nonlinear relationships between past values and future values. More particularly the method predicts short term power demand based on seasonal variations.

In our method, we replace the linear assumption in Holt-Winters smoothing with a more general non-linear relationship between past values and future values. Our method uses the following update equations

Lₜ=α(Xₜ/Iₜ₋ₚ)+(1−α)(\hat{X}ₜ₋₁ (1)/Iₜ₋ₚ) (5)

Iₜ=δ(Xₜ/Lₜ)+(1−δ)Iₜ₋ₚ (6)

\hat{X}ₜ(1)=Iₜ₋ₚFₜ(Lₜ) (7)

where Lₜ and Iₜ denote the local mean level and the seasonal index at time t, respectively. The two auxiliary parameters α and δ denote the smoothing parameters for updating the mean level and seasonal index, respectively, and p denotes the duration of the seasonal pattern. The estimate \hat{X} (1) is the prediction made at time t one time step in the future. Note, our method does not use the trend as in the conventional method.

The vector Lₜ stores past level values, i.e., Lₜ=[Lₜ, Lₜ₋₁, . . . , Lₜ₋ₘ]^{T} for some value of m, and T is a transpose operator.

A nonlinear function Fₜ (L) is used to estimate the current level Lₜ based on past level values. The function Fₜ (Lₜ) can be estimated for each time step t.

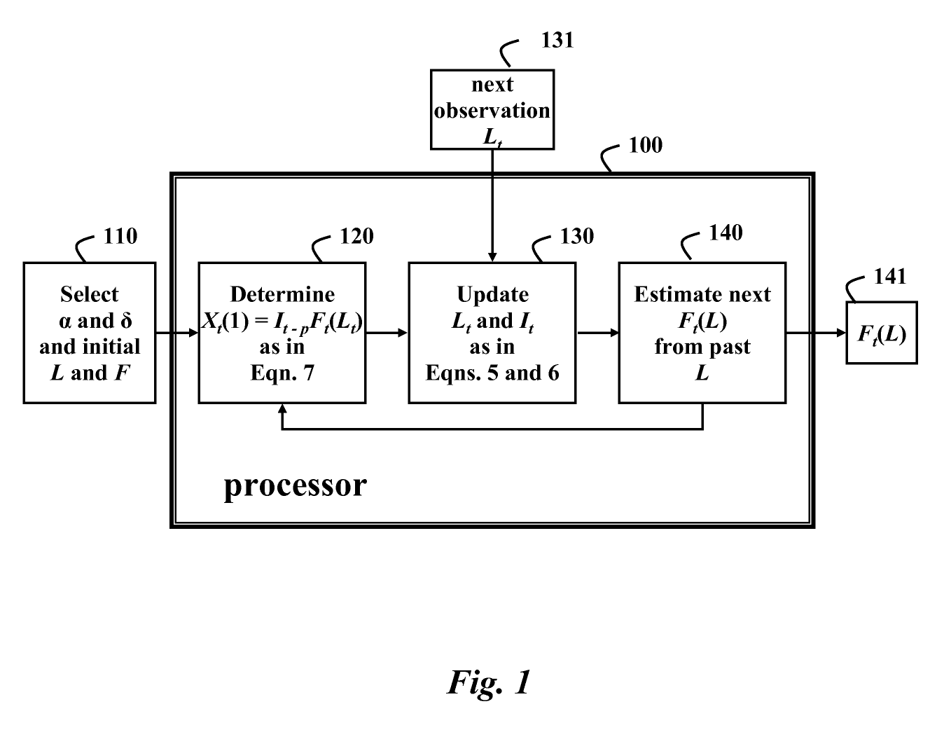

FIG. 1 shows the step of the method. The steps can be performed in a processor 100 including memory and input/output interfaces as known in the art. The method proceeds as follows.

Select 110 parameters α and δ, and initial values for L, I, and F, and for each next observation Lₜ 131 perform the following steps.

Determine 120 \hat{X}ₜ (1)=Iₜ₋ₚFₜ(Lₜ) as in Equation 7.

Acquire an observation Lₜ 131 for the next time step t, and update 130 Lₜ and Iₜ according to Equations 5 and 6.

Estimate 140 a next Fₜ (L) 141 from past values of L.

The estimation of the function Fₜ(L) can be done using any nonlinear estimation technique, for example, a least-squares radial basis function (RBF) regression or support vector regression using a Gaussian kernel.

For example, we can estimate Fₜ(L) using the RBF regression with the last N values of the vector L, i.e., {Lₜ, Lₜ₋₁, . . . , L_{t-M+1}} as training data.

In one application, the method predicts power demand, although the invention can be used to predict any nonlinear time series.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for predicting future values of a time series from past values of the time series, wherein Lₜ and Iₜ are values of an initial local mean level, and a seasonal index at a time t, and α and δ are smoothing parameters for updating the mean level and the seasonal index, respectively, and p is a duration of a seasonal pattern, comprising for each next local mean level Lₜ the steps of:
determining \hat{X}ₜ (1)=Iₜ₋ₚFₜ(Lₜ), wherein \hat{X}ₜ (1) is a prediction made at time t one time step in the future, and Fₜ is a nonlinear function for a vector Lₜ of local level means;
updating the local mean Lₜ and the seasonal index according to
Lₜ=α(Xₜ/Iₜ₋ₚ)+(1−α)(\hat{X}ₜ₋₁ (1)/Iₜ₋ₚ)
Iₜ=δ(Xₜ/Lₜ)+(1−δ)Iₜ₋ₚ; and
estimating a next Fₜ (L) from past values of L, wherein the determining, updating and estimating steps are performed in a processor.

2. The method of claim 1, wherein the time series is short term power demand.

3. The method of claim 1, wherein the time series have seasonal patterns and nonlinear relationships between the past values and the future values.

4. The method of claim 1, wherein the nonlinear function is a least-squares radial basis function.

5. The method of claim 1, wherein the nonlinear function is a support vector regression using a Gaussian kernel.
